(19) United States
(12) Patent Application Publication
(10) Pub. No.: US 2012/0179705 A1
(43) Pub. Date: Jul. 12, 2012

(54) QUERY REFORMULATION IN ASSOCIATION WITH A SEARCH BOX

(75) Inventors: GIRIDHAR KUMARAN, Issaquah, WA (US); TABREEZ GOVANI, Bellevue, WA (US); ABDIGANI MOHAMED DIRIYE, London (GB)

(73) Assignee: MICROSOFT CORPORATION, REDMOND, WA (US)

(21) Appl. No.: 13/004,673

(22) Filed: Jan. 11, 2011

(51) Int. Cl. G06F 17/30

(52) U.S. Cl. 707/767; 707/E17.062

(57) ABSTRACT

Methods and computer-storage media having computer-executable instructions embodied thereon that facilitate reformulating user queries in association with a search box are provided. A user query having a plurality of terms is received and a determination is made that the received user query satisfies a threshold. Based on the received user query, a first set of reformulated user queries is determined. The first set of reformulated user queries includes a plurality of member queries. The plurality of member queries may include one or more suggested query term alterations and/or one or more suggested query term deletions. The member queries may be categorized into groups and/or ranked prior to presentation to a user. A selection option may also be presented for a user to input additional query terms.

### BACKGROUND

Users enter a variety of queries into the search boxes of search engines. While entering such queries, search engines may generate suggestions regarding the query that the user is currently entering into the search box. For example, suggested queries may be generated by a search engine providing an auto-suggest functionality that completes the un-entered characters in a term while the user is entering the characters at the beginning of the term. Such an auto-suggest functionality presents multiple variations of terms, and multiple options for completing an incomplete query. In presenting multiple variations for completing the characters in a term, queries are “expanded,” and users may select the expanded query that was generated using the auto-suggest functionality.

In some instances, while a search engine is presenting expanded queries for terms being entered, the search engine is also generating and displaying search results to the user based on the expanded queries. Although these search results may or may not be relevant to the completed query that the user eventually submits, the combination of auto-suggest completion of a query term and the automatic generation of query results are provided in order to assist users in retrieving the most relevant search results. However, in other instances, users entering lengthy queries with multiple terms into a search box may not utilize the auto-suggest functionality to complete individual terms, and also may not utilize the display of query results prior to completion of the user's intended search.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to user query reformulation in association with a search box. As differentiated from an auto-suggest feature that expands incomplete queries of all lengths, query reformulation refers to the reformulation of user queries that include a plurality of terms already entered by a user. In embodiments, query reformulation is performed on queries that include a particular number of terms that satisfy a threshold. Having received a user query with a plurality of terms that satisfies a threshold, a set of reformulated user queries is determined. Reformulated user queries are presented in association with the search box that received the initial user query, prior to the generation of search results satisfying the user query.

A set of reformulated user queries includes one or more member queries. The member queries include one or more suggestions for a reformulated user query, such as a suggested query term alternation and/or a suggested query term deletion. In one embodiment, reformulated user queries are ranked before being presented to a user. For example, ranked suggested query term alterations and ranked suggested query term deletions may be presented to a user in an order that is most relevant to the user's original query. In another embodiment, reformulated user queries are categorized into groups before being presented to a user in association with such groups. For example, the member queries of a set of reformulated user queries may be grouped into suggested query term alterations and suggested query term deletions.

In further embodiments, member queries in a set of reformulated user queries are presented to a user for selection, in association with a search box. Based on a user's selection of a suggested query term alteration or a suggested query term deletion, query results that satisfy the selected member query are generated. In one embodiment, a selection option is provided for a user to input additional terms in association with the original user query. Having received an additional term, a second set of reformulated user queries may be generated. Alternatively, query results that satisfy a new user query that includes the terms of the original user query and the additional terms input by the user.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is an illustrative display of reformulated user queries determined in accordance with embodiments of the present invention; and

FIGS. 3-8 are flow diagrams showing methods for reformulating user queries, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are generally directed to reformulating user queries in association with a search box. More particularly, reformulated user queries are determined in response to a user query that satisfies a threshold. In some embodiments, the member queries in a set of reformulated user queries are presented to a user. Based on the user's selection of one of the member queries, query results satisfying the selected member query are generated.

In embodiments, reformulated user queries include suggested query term alterations and suggested query term deletions. A suggested query term alteration refers to a reformulated version of the entered user query with at least one of the terms replaced by another term. For example, a reformulated version of the query “verizon wireless phone” may include a suggested query term alteration of “verizon DSL phone,” having the term “wireless” replaced with the term “DSL” in the suggested query term alteration. In embodiments, a query term alteration includes replacing a term and/or a phrase including more than one term. A suggested query term deletion refers to a reformulated version of the entered user query with at least one of the terms removed. For example, a suggested query term deletion for the original query “verizon wireless phone” may include “verizon wireless phone,” with the term “verizon” removed.

Reformulated user queries may be ranked, categorized into groups, and/or presented to a user for selection. Based on a user's selection of a reformulated user query, a number of query results that satisfy the selected reformulated user query are provided. Alternatively, a second set of reformulated user queries may be generated based on a user selection of a reformulated user query. In one embodiment, a selection option is provided for a user to input one or more additional terms. The terms of the original user query and the additional input terms may be used to generate a second set of reformulated user queries. Additionally, a number of query results satisfying the terms of the original user query and additional input terms may be generated.

Accordingly, one embodiment of the present invention is directed to one or more computer-readable media storing computer-useable instructions that, when used by one or more computing devices, causes the one or more computing devices to perform a method of query reformulation. The method comprises: receiving a first user query in association with a search box, the first user query including a plurality of terms; determining that the received first user query satisfies a threshold; and based on the received first user query, determining a first set of reformulated user queries, wherein the first set includes one or more member queries in association with the search box, further wherein the one or more member queries comprises at least one of the following: (1) one or more suggested query term alterations, wherein each of the one or more suggested query term alterations are determined based on replacing at least one term in the received first user query; and (2) one or more suggested query term deletions, wherein each of the one or more suggested query term deletions are determined based on removing at least one term in the received first user query.

In another embodiment, the invention is directed to a method performed by one or more server devices for reformulating user queries. The method comprises: receiving a first user query in association with a search box, the first user query including a plurality of terms; determining that the plurality of terms in the first user query satisfies a threshold; determining a first plurality of reformulated user queries in association with the search box, the first plurality of reformulated user queries comprising: (1) one or more query term alterations, wherein each of the one or more query term alterations are determined based on replacing at least one term in the received first user query; and (2) one or more query term deletions, wherein each of the one or more query term deletions are determined based on removing at least one term in the received first user query; categorizing each of the first plurality of reformulated user queries into one or more groups, the one or more groups comprising: (1) the one or more query term alterations; and (2) the one or more query term deletions.

A further embodiment of the present invention is directed to a graphical user interface stored on one or more computer-storage media and executable by a computing device. The graphical user interface comprises: a search box for receiving a user query, the user query having a plurality of terms; and one or more of the following sections: (1) a section that displays one or more query term alterations in association with the search box, wherein each of the one or more query term alterations are determined based on replacing at least one term in the received user query; and (2) a section that displays one or more query term deletions in association with the search box, wherein each of the one or more query term deletions are determined based on removing at least one term in the received first user query.

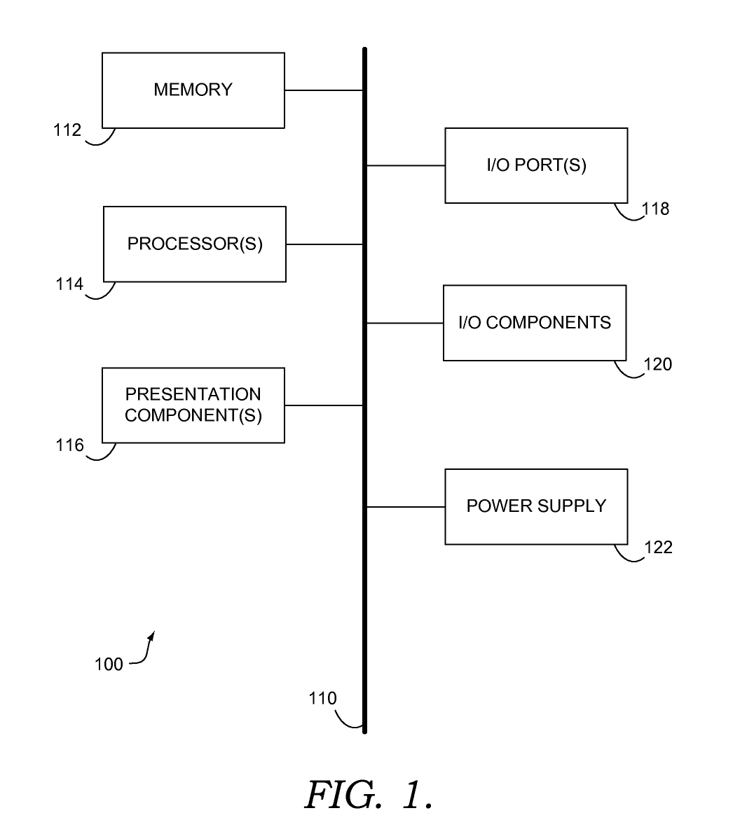

Having described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media accessible by the computing device 100 and includes both volatile and nonvolatile media, and removable and non-removable media, implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above are also included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, etc.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

As indicated previously, embodiments of the present invention are directed to reformulating user queries in association with a search box. A reformulated user query refers to a user query with one or more terms altered, replaced, deleted, removed, corrected for spelling and/or grammatical errors, and/or otherwise changed from the originally-submitted user query. Reformulated user queries are determined from user queries that include a plurality of terms. Based on the plurality of terms satisfying a predetermined threshold, a set of reformulated user queries are determined. In one embodiment, the threshold for determining a set of reformulated user queries requires that the user query includes three or more terms. For example, while the user query “wireless phone” does not trigger the generation of a reformulated user query, the query “verizon wireless phone” does, according to a threshold requiring three terms in the originally-submitted user query. In embodiments, a user query including more than three terms is referred to as a “long” user query. Such “long” user queries may satisfy the threshold for determining a set of reformulated user queries.

Determining a plurality of reformulated user queries utilizes a variety of sources. In embodiments, reformulated user queries are determined using alteration services, query and session logs, and/or alteration scores. An alteration service provides a list of potential alterations to a term and/or phrase (that includes more than one term) in an original user query and an indication of a confidence level of the relevance of the proposed alterations. Query and session logs refer to sources that provide data retrieved from previously-submitted user queries and previous periods of user interaction. Alteration scores refer to the scores assigned to a reformulated user query based on a determined confidence level that the reformulated user query will provide relevant results. As will be discussed in further detail below, reformulated user queries may also be determined using specificity scores, inverse document frequency, and information gain.

Determining which reformulated user queries to present to a user also utilizes a variety of sources, including query and session logs, query quality predictions, alteration scores, suggested term sources, and/or a web document center. Query quality predictions refers to the quality of results retrieved in response to a particular user query, as describe in full detail in U.S. patent application Ser. No. 12/969,140, entitled “Classifying Results of Search Queries,” having Attorney Docket Number 331078.01/MFCP.157702, filed Dec. 15, 2010, which is hereby incorporated by reference. A suggested term source refers to the use of multiple sources from which to retrieve suggested terms. A web document center provides information regarding the content of webpages retrieved in response to a particular query. For example, if the user queries “verizon wireless phone” and the reformulated user query “cingular wireless phone” retrieve search results with similar content, then a determination may be made that the replaced term in the reformulated user query is an appropriate reformulation candidate, such as a suggested query term alteration.

Using one or more of these sources, a score is generated for each type of reformulated user query, including suggested query term alterations and suggested query term deletions. For example, as set of reformulated user queries may include one or more suggested query term alterations (which may also be referred to as the “member queries” in a reformulated user query set). The suggested query term alterations may be scored using one or more of the listed sources, such as the query and session logs, query quality predictions, alteration scores, and/or suggested term sources. Similarly, the member queries of a reformulated user query set including suggested query term deletions may be scored using a variety of the sources listed above, including query and session logs, query quality predictions, and/or alteration scores.

The scores generated for each reformulated user query are used to rank the reformulated user queries. Such ranking may be done using a machine-learned model that is trained to predict the importance and/or relevance of reformulated user queries. Ranking a reformulated user query in relation to the importance and/or relevance of the reformulated user query refers to prioritizing which reformulated queries are most likely to generate results that are responsive to the user's intended query. For example, ranking may determine that a suggested query term alteration with the first term replaced in a query containing three terms is most relevant to a user's intended query. As such, suggested query term alterations with the first terms replaced may be listed near the top of a plurality of member queries presented to a user.

In one embodiment, reformulated user queries may be ranked using a machine-learned model that is trained to predict which term variations (in either a suggested query term alteration or a suggested query term deletion) provides the most relevant search results in relation to the original user query. In further embodiments, additional tools are used to enhance the accuracy of a machine-learned model, such as random flight, alteration scores, positional bias, and the like. As will be understood, the use of a machine-learned model to rank reformulated user queries, and subsequently determining the order in which to present the reformulated user queries to a user, is not limited to one source of information or one method of data generation.

In embodiments, reformulated user queries are presented to a user according to a ranking. For example, higher-ranked reformulated user queries are presented above lower-ranked reformulated user queries. In further embodiments, in addition to rakings that are based on assigned scores, user queries may be presented to a user based on individual logic pertaining to the type of reformulated user query. For example, one suggested query term alterations logic may present member queries in the order of terms that are replaced, such as listing first-term replaced member queries above member queries with a second term replaced. As will be discussed in detail below, suggested query term alterations may be presented to a user based on one associated logic, while suggested query term deletions may be presented to a user based on a different associated logic. As such, although similar sources may be utilized to generate reformulated user queries based on a submitted user query, determining which suggested query term alterations and which query term deletions to display may utilize separate logic.

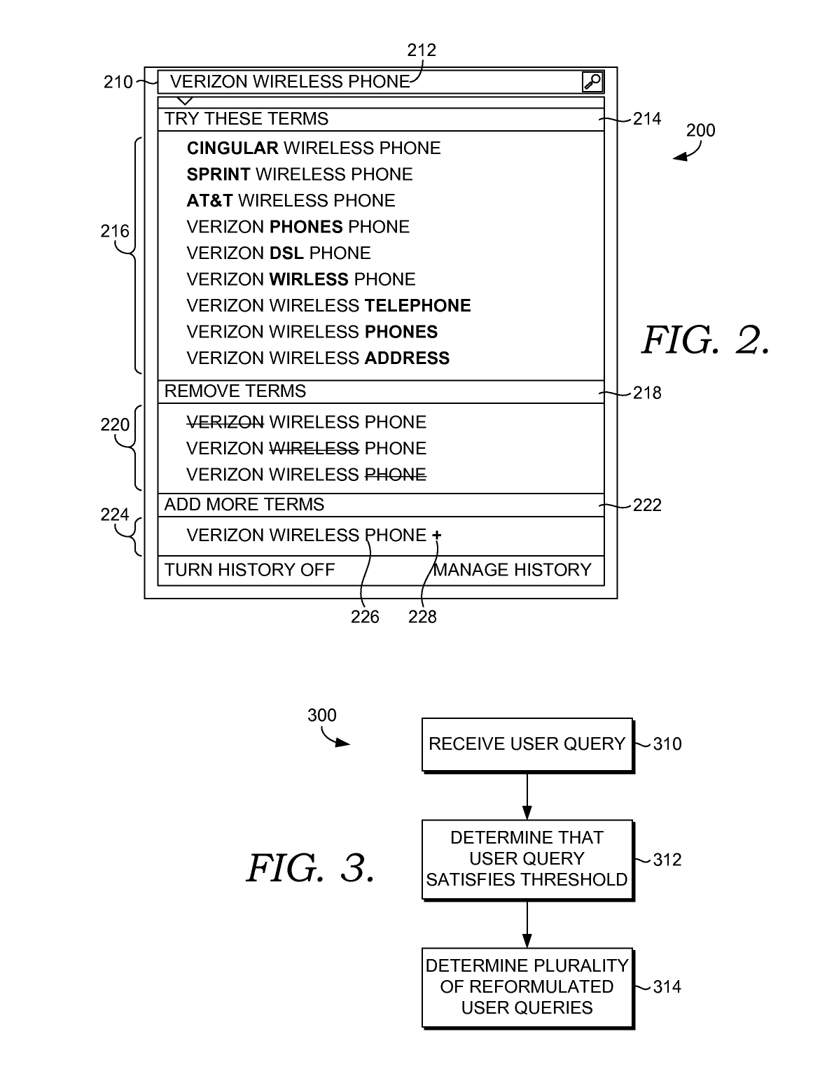

As shown in FIG. 2, an exemplary display 200 illustrates the presentation of reformulated user queries in association with a search box 210. In FIG. 2, the user query 212 satisfies a threshold requiring three or more terms in the user query. In other embodiments, the threshold for determining reformulated user queries may require a different number of terms in the user query. As shown in the illustrated embodiment, suggested query term alterations 214 includes a group of member queries 216, while suggested query term deletions 218 includes a group of member queries 220.

Suggested query term alterations 214 includes member queries 216 which are reformulated user queries with replaced terms. As shown in FIG. 2, each member query 216 includes at least one term altered and/or replaced by a different term in the original user query 212. In one embodiment, the member queries 216 are determined using an alteration service that generates a list of possible alterations used to reformulate a submitted user query. The recommendations provided by the alteration service may be generated based on the same or similar terms that are frequently detected as being searched for together, such as the terms “cingular wireless phone,” “sprint wireless phone,” and “AT&T wireless phone.” In embodiments, the alteration service may use a variety of data sources to determine which query term alterations to suggest, such as click rates, query frequency, query confidence levels, previous user queries, session logs, and the like. An alteration service may also provide a list of suggested query alterations based on a particular level of confidence that the altered member query is likely to provide a result that is relevant to the user's intended query. In other embodiments, sources other than an alteration service may be used in addition to or in alternative to an alteration service. For example, query log data may be independently searched to generate member queries 216 for suggested query term alterations 214.

Suggested query term deletions 218 includes member queries 220 which are reformulated user queries with removed terms. As shown in FIG. 2, each member query 220 has at least one term deleted and/or removed from the original user query 212. In one embodiment, the member queries 220 are determined based on the frequency that a term is searched for by users. Search frequency may be determined from a variety of sources, including query and session logs. For example, if a user enters a query for “v wireless phone,” the most likely candidate term for removal from the query would be the term “v,” because the term “v” is not frequently searched for and therefore does not provide much discriminative power to the user query. In other words, a term may be removed from the user query because it demonstrates a low level of specificity with respect to the entire user query, while other terms in the user query may demonstrate higher levels of specificity. In some embodiments, individual terms in a submitted user query 212 are initially evaluated based on their discriminative power, which is subsequently utilized to determine the member queries 220. Discriminative power may be based on query frequency, or may be based on other data sources, such as click rates and other search log data.

In a further embodiment, a term's specificity score is used to determine which term to remove and/or delete from a user query 212 when determining member queries 220. A specificity score refers to the degree of specificity of a term. In embodiments, “specificity,” or “selectional preference,” of a term t is defined as the divergence between the unigram model of the query language and the unigram model of the sub-language of queries containing t. As such, a score based on such specificity may be used to determine which term to remove and/or delete from a user query 212 when determining member queries 220.

Similarly, in further embodiments, a term's inverse document frequency may be used to determine whether it should be removed and/or deleted from a user query 212. A term's inverse document frequency refers to an equation dividing one by the number of documents on the internet in which the term occurs. As such, a lower inverse document frequency score correlates to a less-specific query term, which further suggests that the term is a better candidate for deletion/removal as part of the member queries 220 in suggested query term deletions 218.

In another embodiment, an alteration service is used to determine member queries 220 for suggested query term deletions 218. For example, an alteration service may detect particular phrases within a user query 212, such as the phrase “wireless phone.” Such phrasal detection may then be used to generate an inverse document frequency for the detected phrase. This may also be referred to as the detection of frequency of bigrams, or pairs of words, on the internet. In further embodiments, information game may be used to determine how well a term in the user query 212 fits with other documents on the internet, which is in turn used to determine which terms to remove.

Suggested query term additions 222 provides an additional query 224, with the original user query 226 and a selection option 228 for indicating that a user intends to add an additional term to the original user query 226. In one embodiment, a user may select the selection option 228 to indicate that the user intends to enter an additional query term. Upon selection of the selection option 228, an additional query term entered by a user may automatically populate the search box 210. Alternatively, an additional query term may be entered in an additional text input box presented to a user based on selection of the selection option 228. While a user is entering an additional term in association with query term additions 222, member queries 216 in suggested query term alterations 214 and member queries 220 in suggested query term deletions 218 remain static, such that a user can view the member queries 216 and 220 in each section while determining which term to add to the original user query 212.

In one embodiment, having entered an additional term, the new user query (including the original user query 212 and the additional term added in association with query term additions 222) is used to retrieve a plurality of search results that satisfy the new user query. In another embodiment, the new user query populates the search box 210, and new sets of member queries 216 and 220 are generated for the new user query.

Referring now to FIG. 3, a flow diagram is provided illustrating a method 300 for reformulating user queries in association with a search box. A user query is received at block 310. The user query includes a plurality of terms. At block 312, a determination is made that the user query satisfies a threshold. As previously discussed, a threshold may be set which determines when a reformulated user query is generated. For example, a user query including three or more terms may satisfy a given threshold, and therefore trigger a determination of reformulated user queries. Based on the determination at block 312, at block 312, a plurality of reformulated user queries are determined. The plurality of reformulated user queries may include one or more suggested query term alterations and/or one or more suggested query term deletions.

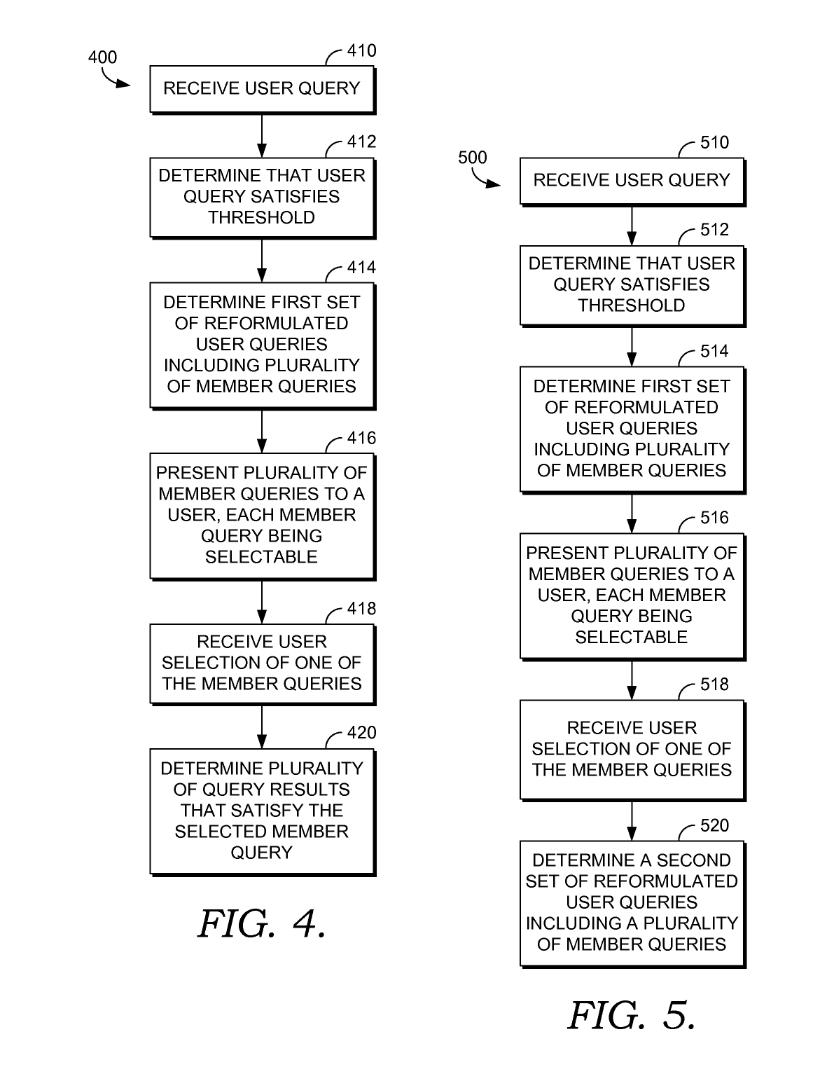

Turning now to FIG. 4, a flow diagram is provided illustrating a method 400 for reformulating user queries in association with a search box. A user query is received at block 410, and a determination is made at block 412 that the user query satisfies a threshold. Based on satisfying the threshold of block 412, at block 414, a first set of reformulated user queries is determined. The first set determined at block 414 includes a plurality of member queries. As used herein, the term “a first set” should not be interpreted as limiting the method to determining only a single set. As such, multiple sets may be determined, with the multiple sets having multiple member queries. At block 416, the plurality of member queries determined at block 414 are presented to a user. Each presented member query is selectable. At block 418, a user selection of one of the selectable member queries is received. A plurality of query results that satisfy the selected member query are then generated at block 420.

With reference now to FIG. 5, a flow diagram is provided illustrating a method 500 for reformulating user queries in association with a search box. A user query is received at block 510 and a determination is made at block 512 that the user query satisfies a threshold. At block 514, a first set of reformulated user queries are determined. The first set includes a plurality of member queries that are reformulated based on the user query received at block 510. For example, as illustrated in FIG. 2, an original user query 212 for “verizon wireless phone,” may be used to generate a first set of reformulated user queries, which includes both suggested query term alterations 214 and suggested query term deletions 218.

At block 516, the plurality of member queries in the first set are presented to a user, with each member query being selectable. At block 518, a user selection of one of the member queries is received. At block 520, a second set of reformulated user queries is determined. The second set of reformulated user queries includes a plurality of member queries. While the first set of member queries determined at block 514 is determined based on the original user query received at block 510, the second set of reformulated user queries is based on the member query selected at block 518.

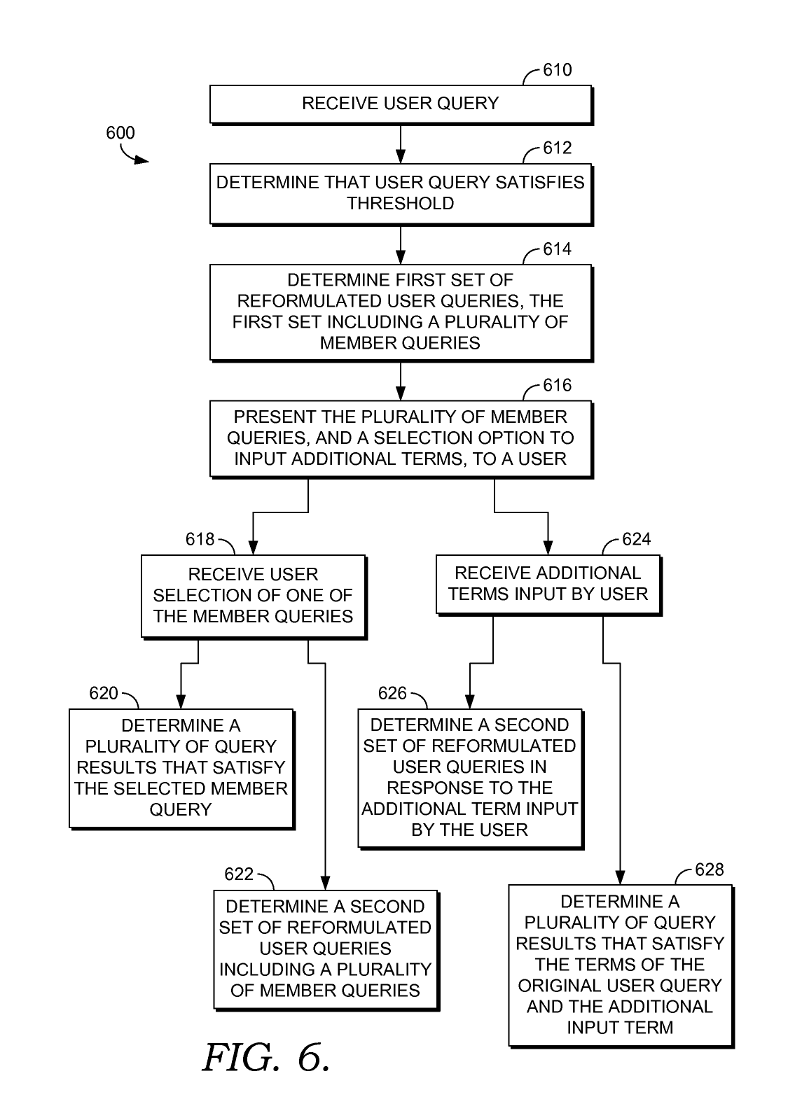

Referring next to FIG. 6, a flow diagram is provided illustrating a method 600 for reformulating user queries in association with a search box. At block 610, a user query is received, having a plurality of query terms. At block 612, a determination is made that the plurality of terms in the received user query satisfies a threshold. At block 614, a first set of reformulated user queries is determined. The first set includes a plurality of member queries that are presented to a user at block 616. Also presented at block 616 is a selection option for a user to input additional terms in association with the user query received at block 610. For example, as illustrated in FIG. 2, a selection option 228 provides an indication for a user to input an additional query term in association with the original user query 212.

At block 618, a user selection of one of the member queries is received. For example, as illustrated in FIG. 2, this may include the selection of a member query 216 of a plurality of suggested query term alterations 214, or the selection of a member query 220 of a plurality of suggested query term deletions 218. Based on the selection at block 618, a plurality of query results that satisfy the selected member query are determined at block 620. In the alternative, at block 622, a second set of reformulated user queries is determined, including a plurality of member queries that are generated based on the selected member query of block 618.

At block 624, based on the selection option presented at block 616, additional terms are input by a user. At block 626, a second set of reformulated user queries are determined in response to the additional term input by the user. Alternatively at block 628, a plurality of query results that satisfy the terms of the original user query and the additional input term may be generated. As previously discussed with reference to FIG. 2, in one embodiment, these additional terms are input based on selection of a selection option 228. In one embodiment, an additional text box may appear based on selection of a selection option. A user may then input the additional term in to the additional text box. In another embodiment, having selected a selection option, the user may be prompted to input the additional term into the same search box 210 as the original user query.

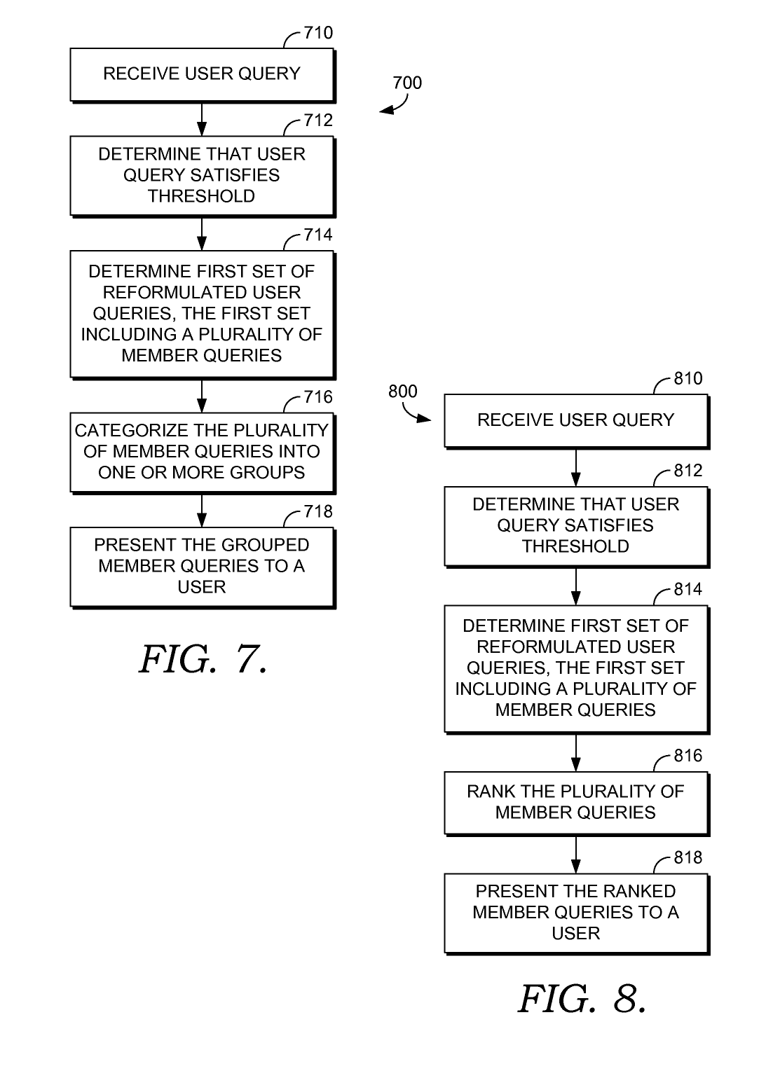

Turning now to FIG. 7, a flow diagram is provided illustrating a method 700 for reformulating user queries in association with a search box. At block 710, a user query is received. A determination is made at block 712 that the user query satisfies a threshold. At block 714 a first set of reformulated user queries is determined. The first set of reformulated user queries includes a plurality of member queries, such as one or more suggested query term alterations and/or one or more suggested query term deletions. At block 716, the plurality of member queries are categorized into groups. Categorizing the plurality of member queries into groups refers to grouping the member queries based on the type of reformulated user query that is determined. For example, a category for suggested query term alterations includes one or more member queries that are grouped together based on having a term in the member query altered and/or replaced by a different term. Additionally, a category for suggested query term deletions includes one or more member queries that are grouped together based on having a term in the member query removed and/or deleted. As previously discussed, a number of sources may be used to derive the first set of reformulated user queries determined at block 714. As such, the plurality of member queries in the first set are grouped at block 716 to aid in presentation to a user at block 718. In embodiments, the member queries categorized into groups at block 716 and presented to a user at block 718 include one or both of suggested query term alternations and suggested query term deletions.

Referring finally to FIG. 8, a flow diagram is provided illustrating a method 800 for reformulating user queries in association with a search box. A user query is received at block 810 and a determination is made at block 812 that the received user query satisfies a threshold. At block 814, a first set of reformulated user queries is determined. The first set of reformulated user queries includes a plurality of member queries. The plurality of member queries are ranked at block 816. As previously discussed, user queries are ranked using a machine-learned model that is trained to predict the importance and/or relevance of reformulated user queries. In one embodiment, a machine-learned model is trained to predict which variations of an original user query (both suggested query term alterations and suggested query term deletions) provides the most relevant search results. Additional tools, such as random flight, alteration scores, positional bias, and the like may also be used to enhance the accuracy of a machine-learned model.

As can be understood, embodiments of the present invention provide a method of reformulating user queries in association with a search box. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media storing computer-useable instructions that, when used by one or more computing devices, causes the one or more computing devices to perform a method of query reformulation, the method comprising:
receiving a first user query in association with a search box, the first user query including a plurality of terms;
determining that the received first user query satisfies a threshold; and
based on the received first user query, determining a first set of reformulated user queries, wherein the first set includes one or more member queries in association with the search box, further wherein the one or more member queries comprises at least one of the following:
(1) one or more suggested query term alterations, wherein each of the one or more suggested query term alterations are determined based on replacing at least one term in the received first user query; and
(2) one or more suggested query term deletions, wherein each of the one or more suggested query term deletions are determined based on removing at least one term in the received first user query.

2. The one or more computer-readable media of claim 1, wherein determining the first set of reformulated user queries includes ranking the one or more member queries in the first set.

3. The one or more computer-readable media of claim 1, wherein the method further comprises:
presenting the one or more member queries to a user prior to determining a plurality of query results that satisfy one or more of the member queries, each of the one or more member queries being selectable and presented in association with the search box, wherein the one or more member queries are categorized into one or more groups, each of the one or more groups comprising:
(1) the one or more suggested query term alterations; and
(2) the one or more suggested query term deletions.

4. The one or more computer-readable media of claim 3, wherein the method further comprises:
receiving a user selection of one of the selectable one or more member queries; and
in response to the user selection, determining a plurality of query results that satisfy the selected member query.

5. The one or more computer-readable media of claim 3, wherein the method further comprises:
receiving a user selection of one of the selectable one or more member queries; and
in response to the user selection, determining a second set of reformulated user queries, wherein the second set includes one or more member queries in association with the search box, further wherein the one or more member queries comprises at least one of the following:
(1) one or more suggested query term alterations, wherein each of the one or more suggested query term alterations are determined based on replacing at least one term in the selected member query; and
(2) one or more suggested query term deletions, wherein each of the one or more suggested query term deletions are determined based on removing at least one term in the selected member query.

6. The one or more computer-readable media of claim 5, wherein determining the second set of reformulated user queries includes ranking the one or more member queries in the second set.

7. The one or more computer-readable media of claim 5, wherein the one or more member queries in the second set are categorized into one or more groups, each of the one or more groups comprising:
(1) the one or more suggested query term alterations; and
(2) the one or more suggested query term deletions.

8. The one or more computer-readable media of claim 3, wherein the method further comprises:
presenting a selection option for a user to input one or more additional query terms, the one or more additional query terms added to the received first user query.

9. The one or more computer-readable media of claim 8, wherein the method further comprises:
receiving one or more additional query terms input by the user;
receiving a second user query, the second user query comprising the received first user query and the one or more additional query terms input by the user; and
determining a plurality of query results that satisfy the received second user query.

10. The one or more computer-readable media of claim 8, wherein the method further comprises:
receiving a second user query, the second user query comprising the first user query and the one or more additional query terms entered by the user; and
determining a third set of reformulated user queries, wherein the third set includes one or more member queries in association with the search box, further wherein the one or more member queries comprises at least one of the following:
(1) one or more suggested query term alterations, wherein each of the one or more suggested query term alterations are determined based on replacing at least one term in the received second user query; and
(2) one or more suggested query term deletions, wherein each of the one or more suggested query term deletions are determined based on removing at least one term in the received second user query.

11. A method performed by one or more server devices for reformulating user queries, the method comprising:
receiving a first user query in association with a search box, the first user query including a plurality of terms;
determining that the plurality of terms in the first user query satisfies a threshold;
determining a first plurality of reformulated user queries in association with the search box, the first plurality of reformulated user queries comprising:
(1) one or more query term alterations, wherein each of the one or more query term alterations are determined based on replacing at least one term in the received first user query; and
(2) one or more query term deletions, wherein each of the one or more query term deletions are determined based on removing at least one term in the received first user query;
categorizing each of the first plurality of reformulated user queries into one or more groups, the one or more groups comprising:
(1) the one or more query term alterations; and
(2) the one or more query term deletions.

12. The method of claim 11, wherein determining the first plurality of reformulated user queries includes ranking the one or more reformulated user query indications.

13. The method of claim 11, wherein the method further comprises:
presenting the first plurality of reformulated user queries to a user prior to determining a plurality of query results that satisfy one or more of the first plurality of reformulated user queries, each of the first plurality of reformulated user queries being selectable and presented in association with the search box.

14. The method of claim 13, wherein the method further comprises:
receiving a user selection of one of the first plurality of reformulated user queries; and
determining a plurality of query results that satisfy the selected reformulated user query.

15. The method of claim 13, wherein the method further comprises:
presenting a selection option for a user to input one or more additional query terms, the one or more additional query terms added to the received first user query.

16. The method of claim 15, wherein the method further comprises:
receiving one or more additional query terms input by the user;
receiving a second user query, the second user query comprising the received first user query and the one or more additional query terms input by the user; and
determining a plurality of query results that satisfy the received second user query.

17. The method of claim 15, wherein the method further comprises:
receiving one or more additional query terms input by the user;
receiving a second user query, the second user query comprising the received first user query and the one or more additional query terms input by the user; and
based on the second user query, determining a second plurality of reformulated user queries, the second plurality of reformulated user queries comprising:
(1) one or more query term alterations, wherein each of the one or more query term alterations are determined based on replacing at least one term in the second user query; and
(2) one or more query term deletions, wherein each of the one or more query term deletions are determined based on removing at least one term in the second user query.
categorizing each of the second plurality of reformulated user query indications into one or more groups, the one or more groups comprising:
(1) the one or more query term alterations; and
(2) the one or more query term deletions.

18. The method of claim 17, wherein the method further comprises:
presenting the second plurality of reformulated user queries to a user prior to determining a plurality of query results that satisfy one or more of the second plurality of reformulated user queries, each of the second plurality of reformulated user queries being selectable and presented in association with the search box.

19. A graphical user interface stored on one or more computer-storage media and executable by a computing device, said graphical user interface comprising:
a search box for receiving a user query, the user query having a plurality of terms; and
one or more of the following sections:
(1) a section that displays one or more query term alterations in association with the search box, wherein each of the one or more query term alterations are determined based on replacing at least one term in the received user query; and
(2) a section that displays one or more query term deletions in association with the search box, wherein each of the one or more query term deletions are determined based on removing at least one term in the received first user query.

20. The graphical user interface of claim 19, wherein the graphical user interface further comprises:
a section that provides a selection option for a user to input one or more additional query terms in association with the search box, the one or more additional query terms added to the received user query.
